(19) United States
(12) Patent Application Publication
(10) Pub. No.: US 2017/0032458 A1
(43) Pub. Date: Feb. 2, 2017

(54) SYSTEMS, METHODS AND DEVICES FOR EXTRACTION, AGGREGATION, ANALYSIS AND REPORTING OF FINANCIAL DATA

(71) Applicant: STRESSCO INC., Toronto (CA)

(72) Inventor: Ron DEMBO, Toronto (CA)

(21) Appl. No.: 15/223,689

(22) Filed: Jul. 29, 2016

Related U.S. Application Data
(60) Provisional application No. 62/198,355, filed on Jul. 29, 2015.
(60) Provisional application No. 62/332,891, filed on May 6, 2016.

(51) Int. Cl. G06Q 40/02; G06F 17/30

(52) U.S. Cl. CPC G06Q 40/02; G06F 17/30563

(57) ABSTRACT

Systems, methods and devices for storing and updating financial data, receiving and processing report requests and generating reports using a cloud based parallel platform with multiple sets of processor engines. The platform arranges atomic elements in a cube or data lake based on a common data model for instruments. The platform uses a set of processor engines to asynchronously update the atomic elements. The platform uses another set of processor engines to asynchronously aggregate a portion of the atomic elements to generate output data in response to on-demand reports.

### CROSS-REFERENCE TO RELATED APPLICATIONS

The present application claims the benefit of and priority to U.S. Provisional Patent Application No. 62/198,355 filed Jul. 29, 2015 and U.S. Provisional Patent Application No. 62/332,891 filed May 6, 2016. The content of each application is incorporated by reference herein.

### FIELD

The improvements generally relate to the field of financial engineering and risk management.

### INTRODUCTION

There is a need in the financial marketplace for quality, independent validation of the potential risks due to market fluctuations. For example, a financial institution and its Board of Directors and senior management may want an accurate and independent assessment of the historical, current and future risks related to the financial institution.

### SUMMARY

In an aspect, there is provided a risk management platform having an interface configured to receive input data from data sources, transforms the input data to compute atomic elements, and store the atomic elements in a distributed data storage device, the atomic elements being additive and modeled using a common data model. The risk management platform having a first set of parallel processor engines configured to continuously monitor the data sources to detect updates to the input data, and generate corresponding updates to the atomic elements in the distributed data storage device, risk management platform having a second set of parallel processor engines to operate on the updated atomic data elements using ETL logic and aggregate the atomic elements using rules. The risk management platform having a reporting unit configured to receive on an demand request for an electronic real-time report, determine required atomic elements for generating the report, trigger the second set of parallel processor engines to aggregate the atomic elements on demand, and generate the report using the aggregated atomic elements, the report providing a plurality of visual representations of the aggregated atomic elements. The risk management platform transforms input data into atomic elements and continuously updates the atomic elements. The risk management platform computes values for instruments by aggregating the atomic elements and generates different visual representations for the aggregated the atomic elements. The visual representations can be derived using distribution values and improve the visualization of the aggregated the atomic elements.

In some embodiments, the first set of parallel processor engines operates asynchronously from the second set of parallel processor engines.

In some embodiments, the input data relates to market factors, instruments and scenarios, and the atomic elements are part of a cube structure of mark to future values for each of a plurality of instruments, wherein the mark to future value for an instrument is a simulated expected value for the instrument under a scenario at a time point.

In some embodiments, the atomic elements correspond to different instruments and different business functions.

In some embodiments, the second set of parallel processor engines to determine that the required atomic elements are available in the data storage device before the aggregation.

In some embodiments, the interface has a market data connector to automatically download market data as the input data from the data sources.

In some embodiments, the interface has a data manager that controls persistence of the atomic elements in a cube data structure or data lake, and transfers the atomic elements to and from an in-memory data cache.

In some embodiments, the input data includes market factor data for pricing and scenarios, and wherein the interface has a market factors manager that controls the persistence of the market factor data in a data storage and transfers the market factor data to and from an in-memory data cache.

In some embodiments, the first set of parallel processor engines comprises a pricing engine that monitors updates to input data relating to market pricing and triggers recalculation of a set of atomic elements for the market pricing.

In some embodiments, the first set of parallel processor engines comprises a scenario engine that monitors updates to input data relating to scenario set variables and triggers recalculation of a set of atomic elements for the scenario set variables.

In another aspect, there is provided a risk management platform having an interface configured to receive input data from data sources, transform the input data into atomic elements using one or more common data models, and store the atomic elements in a distributed cloud data storage device, the atomic elements being additive and representing data required for business functions of a financial institution. The risk management platform having a first set of parallel processor engines configured continuously monitor the data sources to detect updates to the input data, and generate corresponding updates to the atomic elements in the data storage device. The risk management platform having a second set of parallel processor engines to operate on the updated atomic data elements using ETL logic and aggregate the atomic elements using models, scenarios and rules, the a second set of parallel processor engines triggered in response to an demand request for an electronic real-time report. The first set of parallel processor engines and the second set of parallel processor engines operate asynchronously such that the updates to the atomic elements are independent of the aggregation of the atomic elements. The risk management platform having a reporting unit configured to trigger the second set of parallel processor engines to aggregate the atomic element on demand and in real-time and generate a plurality of visual representations of the aggregated atomic elements.

In another aspect, there is provided a risk management platform that automatically computes values for a hierarchy of portfolios of instruments against a large set of scenarios using market factors. The calculation by the risk management platform is triggered by rules such as a rule that indicates that a market risk factor changes by more than some threshold, or a rule that indicates that a change in the scenario set for the factors that affect a particular portfolio. The need for the risk management platform to revalue the values for scenario sets changes with different frequency for the different portfolios. The portfolios will be segregated by the risk management platform into groups that depend on particular risk factors (e.g. interest rates, FX, etc.) The results for each instrument for all scenarios are published or recorded by the risk management platform asynchronously to a data lake or meta-cube data structure. The risk management platform workflow is automated. The risk management platform The risk management platform efficiently and intelligently distributes the calculations to distributed server farms. Different server farms can be used for a distinct instrument and portfolio type. The server farms operate asynchronously and feed their results into a central data lake for aggregation and reporting. The risk management platform automatically scales the server farms as the scope of calculations increases. The risk management platform switches between different sources of market data or compute atomic elements for the data lake using multiple data sources. The risk management platform can switch between different scenario sets and scenario generators. All aggregation and reporting can be done via the data lake. Pricing engines are used by the risk management platform for computing pricing values for the portfolios and instruments.

In another aspect, there is provided a method for risk management that involves receiving at an interface input data from multiple data sources; transforming, using a processor, the input data into atomic elements using one or more common data models, the atomic elements being additive and representing data required for business functions of a financial institution; storing the atomic elements in a distributed cloud data storage device; continuously monitoring the data sources, using a first set of parallel processor engines, to detect updates to the input data, and generate corresponding updates to the atomic elements in the data storage device; operating on the updated atomic data elements using a second set of parallel processor engines to and ETL logic to aggregate the atomic elements using models, scenarios and rules, the operating triggered in response to an demand request for an electronic real-time report, the updates to the atomic data elements being asynchronous from the aggregation of the updated atomic data elements; and generating a plurality of visual representations of the aggregated atomic elements on demand and in real-time.

### DESCRIPTION OF THE DRAWINGS

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a schematic diagram of a simulation platform for banking, insurance or other financial services according to some embodiments.

FIG. 2A is a schematic diagram of a simulation platform for banking, insurance or other financial services according to some embodiments.

FIG. 2B is a schematic diagram of a simulation platform for banking, insurance or other financial services according to some embodiments.

FIG. 2C is a schematic diagram of a simulation platform for banking, insurance or other financial services according to some embodiments.

FIG. 2D is a schematic diagram of a simulation platform for banking, insurance or other financial services according to some embodiments.

FIG. 3 is a flowchart of a process for simulating financial data over scenarios and models to generate on demand reports and visual representations for banking, insurance or other financial services according to some embodiments.

FIGS. 4 to 8 are diagrams of financial instruments, scenarios and functions for multiple pricing engines as example visual representations.

FIGS. 9A and 9B are diagrams of financial instruments, scenarios and functions as example visual representations.

FIGS. 10A and 10B are diagrams of an example user interface providing a visual representation of on-demand financial reporting data according to some embodiments.

FIG. 100 is a diagrams of financial instruments, scenarios and functions as an example visual representation for an application framework.

FIG. 11 is a diagram of an example user interface providing a visual representation of on-demand financial reporting data according to some embodiments.

FIGS. 12 and 13 are example charts providing a visual representation of on-demand financial reporting data according to some embodiments.

FIG. 14 is a schematic diagram of a computing device to implement aspects of simulation platform for banking, insurance or other financial services according to some embodiments.

### DETAILED DESCRIPTION

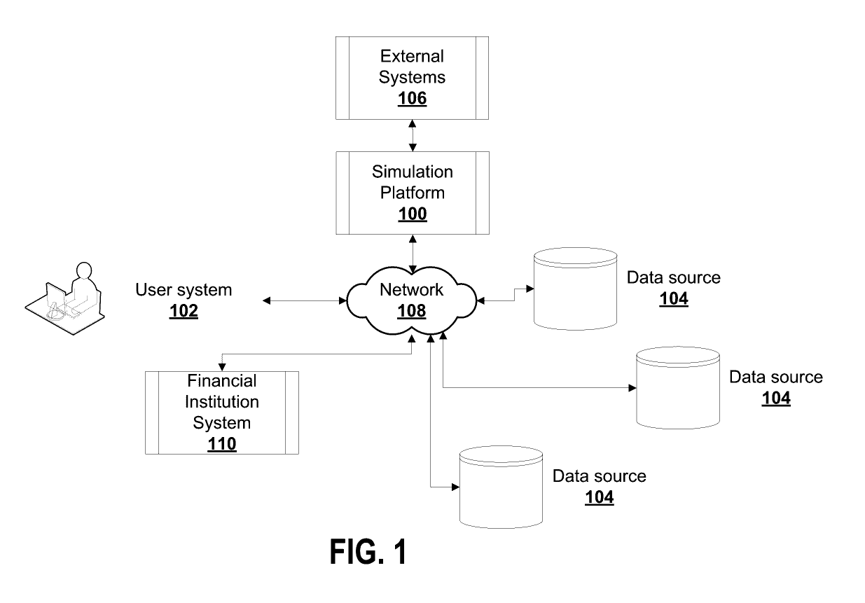

FIG. 1 is a schematic diagram of a platform 100 for banking, insurance or other financial services according to some embodiments. The platform 100 is a parallel and horizontal processing platform that will power banks, insurance companies and other financial services organizations to receive on-demand risk assessments and stress-testing reports for various portfolios, books, financial instruments, customers, and so on. A banking book or portfolio may implicate a significant portion of the business and risk for financial services organizations.

Embodiments described herein relate to a platform 100 that provides “software as a service” for evaluating risk for financial institutions. The platform 100 extracts, computes, aggregates, transforms, processes and outputs benchmark financial reporting data. The platform 100 may allow, for example, financial institutions to compare their portfolios' risk assessment to those of their peers, in an anonymous manner.

The platform 100 stores, processes and aggregates big data with massive parallel processing. The platform 100 may provide a cloud based risk management as a service. The solution may change the way organizations view, process and manage their risk data.

Risk assessment of financial institutions is an integral part of the oversight and management of their risks and health. It is a fundamental requirement of the regulators of financial markets wherever they exist.

Risk assessment of a financial institution is a costly, complex and onerous task, which is made more difficult by the fractured and siloed nature of these institutions. Moreover, there is a need for an oversight function provided by regulators or boards to have an independent assessment of the risk under various possible future market conditions. Today, in all the financial institution we know, there is no truly independent stress testing made available to the board. This makes it difficult for senior managers and the Board to execute appropriate judgment and poses a significant governance problem. There is also a need for benchmarking of financial institution data relative to a peer group under different scenarios. Finally, stress testing is fundamental to the risk management of financial institutions and is not simply a compliance issue.

Embodiments described herein may provide a platform 100 to implement a risk assessment solution that may permit a financial institution to benchmark their in-house risk assessment with a robust, independent stress testing solution. It can permit financial institutions to view their risk independently and anonymously against a group of other financial institutions. It will also provide the board of banks with independent oversight of their stress testing capabilities.

The platform 100 may offer rapid stress testing and risk assessment of an entire portfolio of a bank, for example. The platform 100 may bring stress testing and risk assessment out of the realm of regulatory compliance and into the mainstream management of a bank's portfolio. The platform 100 uses parallel processing hardware technology to scale large processing tasks by splitting into sub processes using grid computing technology.

For example a small to medium-sized bank may not have a sufficient budget to produce its own stress testing solution. The described solution may cut the costs of stress testing for these financial institutions and provide them with stress testing on a par with the largest financial institutions in the world.

The platform 100 may enable rapid stress testing of very large and complex portfolios with improved processing techniques. The technology combines, financial engineering, big data and massive parallel processing engines in a cloud computing configuration to enable the stress testing of multiple financial institutions rapidly and economically at a speed not available anywhere today.

The platform 100 may implement data protection techniques to provide services securely and confidentially to institution being tested. The cloud based, infrastructure may require minimal additional hardware and infrastructure from to institution being tested.

The platform 100 may provide for independent verification of the institution's own stress tests as well as independent oversight and benchmarking reports to the board. The computing platform technology may provide stress-testing-as-a-service model to revolutionize the industry and change the way risk is managed electronically.

Stress testing may consider different scenarios and models and their impact on stress calculations for portfolios of instruments. The technology may provide a “macro to micro” process remodelling. For example, a change in the price of oil may impact financial instruments in a portfolio. Stress testing may provide insight as to how a portfolio should be modified under different scenarios, and how scenarios may impact structure of company operations over time steps.

An example embodiment of the platform 100 may be used to aggregate and process data representing instruments simulated using processors over scenario paths and time steps. The data may be stored in a cube data structure. A cube structure may be used to represent a collection of risk factors and corresponding levels for a portfolio over time steps. For example, MARK-TO-FUTURE A FRAMEWORK FOR MEASURING RISK AND REWARD, May 2000 by the present inventor describes a simulation framework that measures risk and reward of portfolios. At any point in time, the levels of a collection of risk factors determine the mark-to-market value of a portfolio. Scenarios on these risk factors determine the distribution of possible mark-to-market values. Scenarios on the evolution of these risk factors determine the distribution of possible Mark-to-Future (MtF) values over time. An MtF framework uses scenarios as input and the enables the calculation of future mark-to-market values that capture future uncertainty across scenarios and time steps. The MtF framework implements steps to generate an MtF cube of MtF values. The MtF cube is an example cube structure. The cube structure has one dimension representing instruments, one dimension representing scenarios for risk or market factors, and one dimension representing time steps. To generate the MtF cube, first, a set of scenarios is chosen. A scenario is a complete description of the evolution of key risk factors over time. Then an MtF table is generated for a given financial instrument. Each cell of the MtF table contains the computed MtF value for that financial instrument under a given scenario at a specified time step. An MtF Cube consists of a set of MtF tables, one for each financial instrument of interest.

In certain applications, a cell of the MtF Cube may contain other measures in addition to its MtF value, such as an instrument's MtF delta or MtF duration. In a general case, each cell of an MtF Cube contains a vector of risk-factor dependent measures for a given instrument under a given scenario and time step. In some applications, the vector may also contain a set of risk-factor dependent MtF cash flows for each scenario and time step. For ease of explanation, however, an example is that each cell contains only the instrument's MtF value. An MtF Cube contains the necessary information about the values of individual instruments and a portfolio MtF table can be created as a combination of those basis instruments. Risk and reward analyses and portfolio dynamics for any set of holdings are, therefore, derived by post-processing the contents of the MtF Cube.

The platform 100 can construct a cube structure (similar to an MtF cube) of electronic data which in turn can be used to automatically derive sub-cube structures for generating risk measurements. The platform 100 can determine or define data for scenario paths and time steps. Scenarios of risk factors may determine distributions of possible values. Scenarios on the evolution of these risk factors determine the distribution of possible values over time. Scenarios may capture future uncertainty over time steps to provide a measure of future risk for instruments in a portfolio.

The platform 100 can determine or define basis instruments. The platform 100 can simulate the instruments using processors over scenario paths and time steps to generate the cube structure representation. The cube structure may be mapped to portfolios to generate a portfolio table. The platform 100 can aggregate across dimensions of the portfolio table to produce risk measurement output data. The technology may aggregate across dimensions of the portfolio data in the cube structure to produce risk measures, for example.

The platform 100 may generate a wrapper processing and aggregation layer around the cube structure to modify and transform output processing, models and scenarios. The platform 100 may integrate with the cube structure using an API and formal calls or commands. The platform 100 may integrate with different cube structures such that the cube structures are replaceable and changeable.

For example, there may be one cube structure for all organizations, or different cube structures for different organizations, or different cube structures for one organization, and so on. As an example illustration, a financial institution may implement trades based on generally one of 200,000 securities (e.g. instruments) in a portfolio. A cube structure may be generated to represent all 200,000 securities for all scenarios over all points of time. The platform 100 may aggregate a value of every portfolio of every fund manager stressed under the cube structure to generate risk measurement output data. The platform 100 may provide a processing and aggregation solution for a “big data” problem given the number of possible instruments and permutations of instruments that may be stress tested.

In some embodiments, the platform 100 may receive a cube structure as input representing instruments in a portfolio and scenarios at various points in time. As an illustrative example of a “big data” problem, consider that counterparty credit for even on institution may result in a cube structure will over multiple trillions of cells (or data values) for the instruments simulated over the scenarios and time steps. This is a large amount of data to process.

The platform 100 may offer a stress testing or risk management on-demand cloud service that integrates with an institutions model data structures and disparate input data sources for the instruments subject to risk and stress.

The platform 100 may be scalable by using a computed cube structure for all scenarios, in an example embodiment. The platform 100 may implement parallel processing and aggregating techniques in a specific way to maintain path dependency and generate stress testing or risk management output data. The computing platform includes a massive parallel machine to implement aggregation of the cube structure data. The platform 100 implements “post-cube” aggregation, processing and transformations on the cube structure to provide stress output data.

The platform 100 may integrate with a risk management engine and aggregation machine to implement data transformations and to use different models and data sets under portfolios to enable benchmarking of stress or risk output data. The platform 100 provides a benchmark representation for institution's risk management data. For example, the platform 100 may independently benchmark a stress test for one type of market or risk factor or environmental factor for institutions. A regulatory body may send out a sample portfolio to institutions to stress test in order to evaluate whether the institution can stress test effectively. Different institutions may test under the same model with same dataset to benchmark against other institutions. The platform 100 may scale aggregation of results to offer different kinds of benchmarking for institutions.

The stress data output may enable an institution to provide variable trade rates, for example (e.g. a low risk trade may be at a different rate then a high risk trade).

The platform 100 may implement work flows for cube management including updates, synchronization, and archival.

The platform 100 may take a macro scenario and turn it into a micro scenario (e.g. oil price to interest rates to transportation rates) to evaluate stress data for an institution. The platform 100 may aggregate data across multiple cube structures to benchmark for the institution. The same institutions may trade the same 200,000 instruments so cube structures representing those instruments may be re-used for different institutions. The computing platform may use one cube structure, for example, with different combinations of cube elements to aggregate the results and generate stress output data (e.g. an aggregation of the cube based on instruments in different portfolios under different models).

The platform 100 may implement scalable processing techniques to spread processing intensive calculations across multiple machines (e.g. even hundreds or thousands if needed for a processing job).

As shown in FIG. 1, platform 100 connects via network 108 to multiple data sources 104 to receive financial data, models, scenarios, instruments, mark or risk factors, business rules and so on. Financial institution system 110 can also provide one or more data sources 104. Financial institution system 110 connects to platform 100 to request on-demand real time reports for risk assessment and stress testing data. Platform 100 may transmit the generated on demand reports to financial institution system 110 or other user system 102 for display as part of a user interface. Platform 100 also connects to external systems 106, such as regulatory or government systems to receive data and report requests and provide on demand report results.

Platform 100 generally implements the following functions (a) storing source data as atomic elements that are additive, (b) monitoring and updating the atomic elements using parallel processor engines, and (c) on demand report generation by aggregating the atomic elements by parallel processor engines. Other functionality is described herein.

Atomic elements provide the set of data needed to compute measurements for all the different functions of the bank or the functions that the bank performs in the course of its business. The atomic elements of an instrument or security are the values that are needed to compute measurements related to the security. Atomic elements are additive and cumulative. For example, atomic elements of Instrument A can be added to atomic elements of Instrument B and the added (+) atomic elements are equal to the atomic elements of a portfolio of Instruments A+B. The atomic elements of a portfolio of instruments are equal to the sum of the atomic elements for the individual instruments that make up the portfolio. Atomic elements are modeled using one or more common data models.

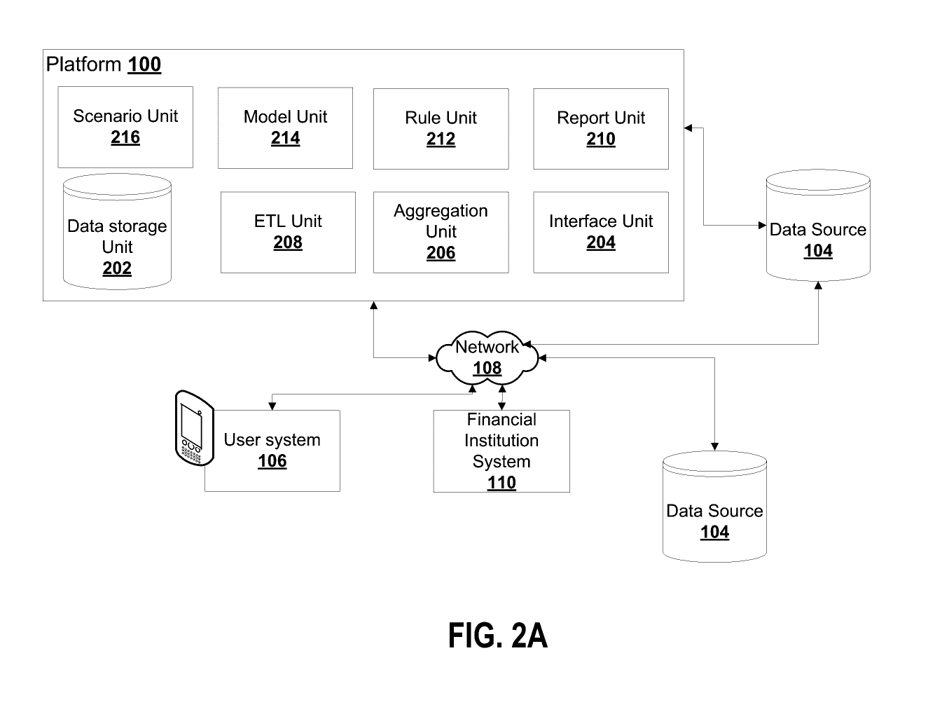

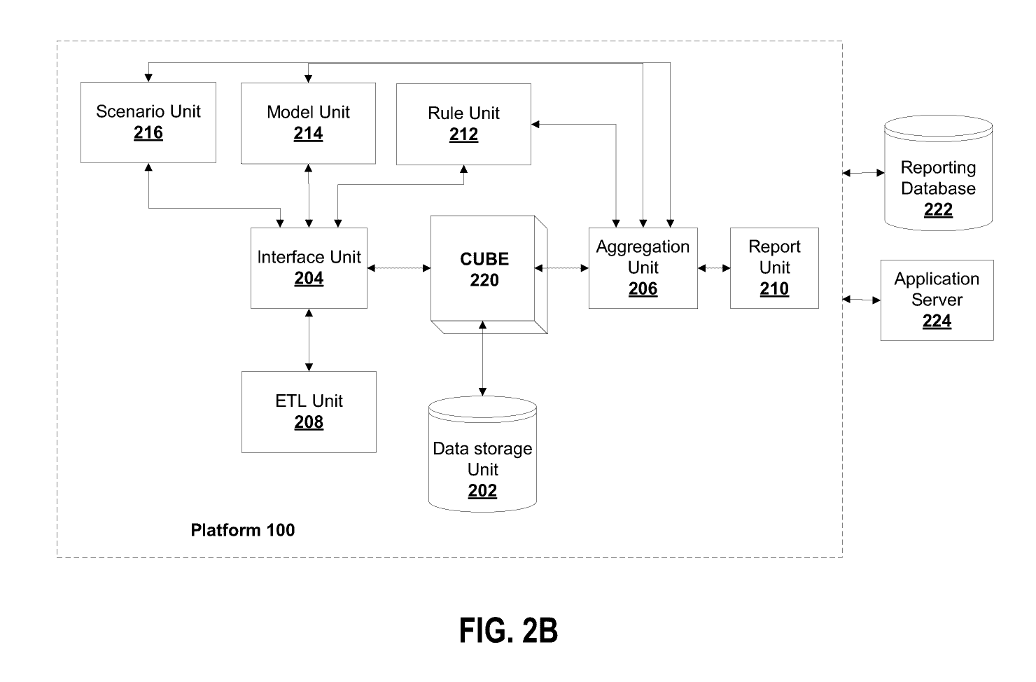

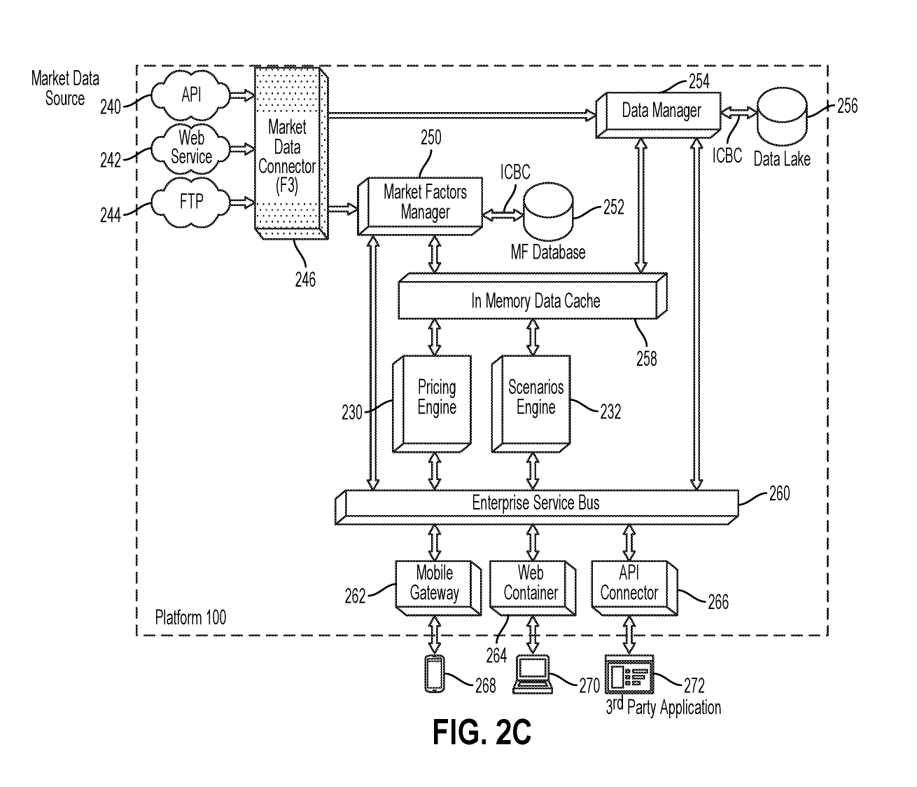

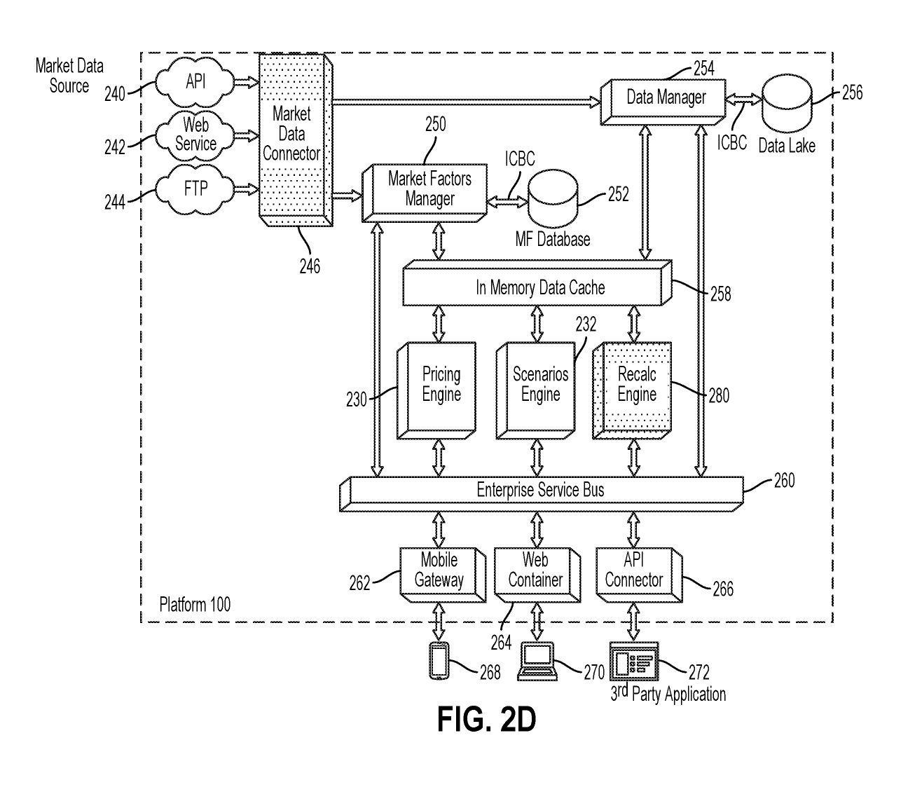

FIGS. 2A and 2B show other example schematic diagrams of platform 100 according to some embodiments.

Platform 100 has an interface unit 204 configured to receive financial instrument data from data sources 104, extract electronic atomic elements from the financial instrument data, and store the electronic atomic elements in a data storage device 202. Interface unit 204 segments and transforms financial instrument data into electronic atomic elements using one or more common data models so that the electronic atomic elements are additive. The additive property facilitates efficient and flexible aggregation of the electronic atomic elements. Atomic elements that are additive can be aggregated by aggregation unit 206 in various ways for provision to report unit 210 to generate on-demand reports. The atomic elements are stored in data storage unit 202. The atomic elements are stored in additive form so that they are ready for aggregation and processing on demand and in real-time.

The interface unit 204 monitors the data sources 104 to detect updates to the data used to derive the atomic elements. Upon detecting an update to the data, the interface unit 204 generates corresponding updates to the atomic elements in the data storage device. Financial data is changing and updating in real-time and so the corresponding additive atomic elements also need updating in real-time or near real-time. Atomic data elements include data for financial instruments, market or risk factors, scenarios, simulations of instruments on scenarios over time as MtF values, dependencies between data, and so on. For example, market factors impact instruments to generate atomic elements for cube 220. The interface unit 204 detects changes to market factors to trigger regeneration of atomic elements of cube 220. The interface unit manages the cube 220 to update the atomic elements based on the updated data. The interface unit 204 asynchronously updates the atomic elements of the cube 220 to ensure the data values of up to date for on demand report generation. The cube 220 can contain documents and electronic files relating to instruments for automatic evaluation of smart contracts. The cube 220 can contain a dependency graph between market factors and MtF values to trigger updates to the MtF values, for example.

In some embodiments, rule unit 212 triggers interface unit 204 to update to atomic elements in response to a rule executing. For example, a rule may indicate that an interest rate changes by more than three points before the dependent atomic elements are updated in cube 220.

The interface unit 204 uses parallel processing engines to asynchronous detect updates and generate corresponding updates to the atomic elements. The interface unit 204 runs parallel processing engines in the background to manage the atomic elements and updates thereto. The interface unit 204 is responsible to ensure all the atomic elements are up to date and ready for aggregation to generate reports on-demand. Any update to data that impacts an atomic element triggers interface unit 204 to detect such update and make a corresponding update to the atomic element. Accordingly, interface unit 204 extracts atomic elements from financial data and updates the extracted atomic elements in response to detected updates to the financial data. The interface unit 204 interacts with extract, transfer, load (ETL) unit 208 to extract the atomic elements from data sources 104.

The interface unit 204 stores data relevant to risk measurement output data in data storage unit 202 as atomic elements based on a common data model. Using a common data model enables the atomic elements to be additive for aggregation.

The interface unit 204 receives input data from data source 104 that includes scenarios sets, instruments and market or risk factors. The interface unit 204 can connect to different scenario generators (as different data sources 104) to receive different scenario sets. The interface unit 204 can generate and update a cube 220 structure using the instruments, market or risk factors and scenario sets.

Scenario unit 216 generates scenarios used to generate atomic data elements and the cube 220 structure. Scenarios may be generated and updated independently from report generations and data extraction.

Model unit 214 manages models used to generate reports. Models may be generated and updated independently from report generations and data extraction. Model unit 214 also manages data models for atomic elements.

Rule unit 212 manages rules used to trigger updates to the atomic data elements and to generate reports. Rules may be generated and updated independently from report generations and data extraction. Rule unit 212 can evaluate rules to trigger updates by interface unit 204.

Aggregation unit 206 can provide a variety of views of the aggregated data. The level of aggregation is to a level that is granular enough to preserve the risk-related characteristics of the aggregate. For example, for a bank's domestic residential mortgage loans portfolio, the aggregation may create the following three sub-groupings to start with: First Lien mortgages; Home Equity Lines of Credit (HELOCs); and Home Equity Loans (HELOANs). In the first sub-grouping, the mortgages may be further sub-divided in to Adjustable Rate Mortgages (ARMs), Fixed Rate Mortgages, and Option Adjustable Rate Mortgages. Within each of the five subgroupings, information would be retained on the payment status of each mortgage: Current, Delinquent (based on number of days past-due) in default, or paid-off.

Aggregation unit 206 can retain a number of other alternative aggregation schemas in order to provide a different view of the mortgage portfolio depending on the issue of interest or concern. The alternative schema can be invoked on-demand so that the desired views are created and made available for users to view in real time.

Scenario unit 216 provides the baseline and stress scenarios that contain baseline or stressed values of the risk factors for different portfolios held in the aggregation unit 206, over a pre-specified future stress horizon. All of the accumulated information can be subjected to the relevant pricing functions. This yields report results that can be viewed live by users, archived for later use, or sent to the report writing applications.

Platform 100 has sandbox functionality that allows for “what-if” queries or requests to be asked on-demand, and for the results to be produced in near real time. The what-if questions can range over a variety of situations, e.g., a change in an input data item; a modified aggregation scheme; an alternative pricing model or calibration thereof; or a different scenario or set thereof. The impact of the change can be traced and viewed all the way through the process.

Report unit 210 is configured to receive an on demand request for an electronic real-time report and determine required atomic elements for generating the report. The report unit 210 interacts with aggregation unit 206 to trigger a parallel processor to determine that the required atomic elements are available in the data storage device 202. Aggregation unit 206 retrieves the updated atomic data elements from data storage device 202 using ETL unit 208, and aggregates the atomic elements using models, scenarios and rules from model unit 214, scenario unit 216, and rule unit 212. Report unit 210 is configured to generate the report using the aggregated atomic elements. The report has a visual representation of different views of the aggregated atomic elements.

According to embodiments described herein, platform 100 provides for real-time distributed computing of stress and risk output data. The computing platform interfaces with multiple disparate data sources 104, sets of models, sets of scenarios and sets of business rules. The platform 100 includes ETL unit 208, aggregation unit 206 and report unit 210 with grid computing and parallel processing hardware. The platform 100 may provide Risk Assessment Software as a Service (SaaS) for an end-user device 104 or financial system 110. The platform 100 may provide for transparency all the way to the transaction data. The platform 100 may change inputs and see results that update in real time. The platform 100 may use any set of models (internal models, institution models, and third party models). The platform 100 may easily compare result sets. The true grid computing means that calculations that took many hours are now reduced to seconds. User can generate ad hoc aggregations at any level. The ETL unit 208 is another part of the computation and the platform 100 may change the ETL logic, models, scenarios and rules and see results update in real time. The model unit 214, scenario unit 216, and rule unit 212 manage the models, scenarios and rules separately from the underlying atomic elements so that they may be update separately or asynchronously. The atomic elements, the models, scenarios and rules are ready to respond to on demand report requests.

The platform 100 allows for quick, on-demand assembly of all data, computations and reporting to carry out near real-time stress test, valuation and risk assessment exercises for a financial institution. The computing application may solve problems of data gathering, computation, speed, and transparency that are prevalent in the stress testing of financial institutions.

The platform 100 may make stress testing valuation and risk assessment quick and efficient. In contrast to the current approach, the speed and efficiency are gained through on-demand assembly of all input data and through use of massively parallel processing.

An example stress testing process may use the platform 100. All input data is extracted as atomic elements to be assembled on-demand. The user can generate ad hoc and custom aggregations at any desired level. The ETL logic, rather than being disconnected from data or analytics, is just another part of computations. The user can change the logic and see results updated in real time. The transparency is maintained all the way to the transaction data. Again, the user can change the inputs and see results updated in real time.

FIGS. 20 and 2D show other example schematic diagrams of platform 100 according to some embodiments.

The platform 100 has an application programming interface (API) 240, web services 242 and an FTP 244 to continuously receive market data from different data sources and transmit output data (e.g. visual representations for interfaces, reports). The platform 100 receives real-time and near real-time data.

The platform 100 has a market data connector 246 that connects to the API 240, web services 242 and an FTP 244 to automatically download market data from these external sources. The market data connector 246 also transmits data requests and output data. The adapter 246 transforms data depending on the source format and data type.

The market data connector 246 maps received data into different atomic data elements using one or more data models. The market data connector 246 has access to metadata defining dependencies between data for atomic elements. The market data connector 246 has access to metadata defining data types. For example, the market data connector 246 determines that received data corresponds to different types of market risk factors so that corresponding atomic data elements are populated with the appropriate received data and updated based on updates to data that are used to derive or otherwise impact the atomic data elements.

The platform 100 has a data manager 254 that stores and updates atomic data elements in the data lake 256. The data lake may also be referred to as a cube data structure according to some embodiments. The data manager 254 controls persistence of market data in the data lake 256 and transfers data to and from the in-memory data cache 258. The data manager 254 updates atomic data elements in the data lake 256 in response to updates to the underlying data. The data manager 254 interacts with data mapper 248 to determine data dependencies and data types for atomic data elements. The data manager 254 asynchronously updates the atomic data elements to ensure they are up to date and ready for aggregation in response to on-demand report requests. The data manager 254 extracts atomic elements in the data lake 256 for provision to pricing engine 230, scenario engine 232 and recalculation engine 280 via in-memory data cache 258. The data manager 254 can have functionality that corresponds to interface unit 204 and other functionality relating to atomic data described herein.

The platform 100 has a market factors manager 250 that receives market data relating to market or risk factors to populate and update market factor data in the market factor database 252. The market factors manager 250 controls the persistence of market factors (e.g. pricing of instruments and scenarios) in the market factor database 252. The market factors manager 250 transmits and receives market factor data to and from the in-memory data cache 258. Market or risk factors are used for scenarios and impact valuation of instruments at different time steps. The market factors impact atomic elements in the data lake 256, such as MtF values. The market factors manager 250 can have functionality that corresponds to interface unit 204 and other functionality relating to market or risk factors values and MtF values described herein.

The platform 100 has an in-memory data cache 258 that interfaces between the data manager 254, market factor manager 250, rules engine 230 and scenario engine 232 to exchange data between the components. For example, the data manager 254 can send and receive scenario sets to and from scenario engine 232 via in-memory data cache 258. For example, the data manager 254 can send and receive atomic elements to and from the data lake via in-memory data cache 258 and enterprise service bus 260.

The platform 100 has a pricing engine 230 the controls changes of market pricing variables for atomic data stored in the data lake 256 and for output data for report generation. The pricing engine 300 triggers a recalculation of a portion of the atomic elements of the data lake 256 affected by scenarios. The pricing engine 230 generates MtF values as atomic elements in the data lake 256, for example. The pricing engine 230 can have functionality that corresponds to interface unit 204 and other functionality relating to MtF values and instruments described herein. The pricing engine 230 can operate asynchronously from other components. The pricing engine 230 can have functionality that corresponds to report unit 210 and aggregation unit 206 to generate reports of output data by aggregating atomic data elements in data lake 256, for example.

The platform 100 has a scenario engine 232 that controls changes of market scenario set variables. The scenario engine 232 triggers a recalculation of a portion of the atomic elements of the data lake 256 affected by scenarios. The scenario engine 232 can have functionality that corresponds to scenario unit 216 and other functionality relating to scenarios described herein. The scenario engine 232 can operate asynchronously from other components.

The platform 100 has a recalculation engine 280 that is triggered by the pricing engine 230 or scenario engine 232 to recalculate atomic elements that are derived from updated market data. The recalculation engine 280 posts updates to atomic elements in data lake 256 through the data manager 254. The recalculation engine 280 can operate asynchronously from other components to ensure that the atomic data elements of data lake 256.

The platform 100 has a mobile gateway 262 to serve mobile applications on mobile device 268. The platform 100 has a web container 264 to serve web applications on computing device 270. The platform 100 has an API connector 266 to serve other third party applications.

The platform 100 has an enterprise service bus (ESB) 260 that transmits data between components. For example, the ESB 260 sends and receives data to and from market factors manager 250, pricing engine 230, scenario engine 232, recalculation engine 280 and data manager 254. The ESB 260 can receive atomic data elements. As another example, the ESB 260 sends and receives data to and from the mobile gateway 262, web container 264, API connector 266. The ESB 260 receives on-demand report requests from mobile gateway 262, web container 264, API connector 266 and transmits output data calculated by pricing engine 230 in response. The platform 100 can include multiple aggregation engines (not shown) that aggregate atomic elements to generate output data for reports.

The platform 100 is able to automatically value a hierarchy of books against a large set of scenarios. This calculation would be automatically triggered by rules unit 212 or pricing engine 230. For example, a rule can trigger an update if USD Libor changes by more than a certain amount. The need to revalue the portfolios or scenario sets changes with different frequency for the different books. The revalue can be triggered by a change in the scenario set for the factors that affect that particular portfolios, or if a market risk factor changes by more than some threshold which triggers a need for re-evaluation, for example. The portfolios can be segregated into groups that depend on particular risk factors, such as interest rates, FX, and so on.

The results for each instrument for all scenarios would be published asynchronously to a data lake 256 (or meta cube 220). A data manager 254 and recalculation engine 280 coordinates updates to the data lake 256. The data lake 256 can be implemented using cloud servers to provide a cloud based storage solution.

The workflow is automated. The web version can be used to create a way of auditing, setting and monitoring this workflow. The calculations can be efficiently and intelligently distributed and triggered on an as needed basis. For example, a Rates book could be sent to Server Farm1, and an Equities book sent to Server Farm2, and so on. These servers can operate asynchronously, keeping the meta data lake 256 and cube 220 as up to date as possible. All servers would feed their results into a central data cube 220 in core for aggregation and reporting. The number of servers can be automatically increased as the scope of the calculation increases (e.g., more portfolios added). In some examples, each instrument could be operated on by a different server.

The platform 100 can switch data sources 104 of market data; or run the analysis with multiple data sources 104 of market data. In some embodiments, the platform 100 can out the scenario generator unit 216; or the scenario sets. All reporting can be implemented using the data lake 256 and cube 220. The model unit 214 can develop and manage pricing models for the banking book assets and parallelism can be used for efficient valuation.

Embodiments described may completely change the way risk management is used in a financial institution. Instead of it being this painfully slow, expensive function that is set up for regulatory purposes only, the computing platform providing SaaS can be used in planning, treasury management and can also provide a Board with independent stress testing results on demand.

Using the platform 100 providing SaaS, a financial institution is able to test its model risk, evaluate different business rules for harmonizing data and provide transparency in the stress testing function.

The set-up allows for a stress test to be run under any number of stress scenarios, using multiple sets of models and different sets of business rules. This allows for comparison of results under any desired combination of scenarios, models and business rules.

The source data and reports may relate to different aspects of a financial institution. For example, the source data and reports may relate to operations including document management, messaging, matching and confirming reconciliations, trading confirmations and statements. The source data and reports may relate to sales such as counterparty data, sales reports and analysis, CRM integration data, customer onboarding. The source data and reports may relate to trading such as trade blotters, position aggregation, ticket entry, trade execution, and order management. The source data and reports may relate to risk such as derivative pricing, scenario analysis, VAR and other risk metrics, and dashboards. The source data and reports may relate to settlements, cash management, net and gross settlement processing, bank reconciliation, and beneficiary management. The source data and reports may relate to IT and security, integrated development environments, open, scalable and secure APIs, plug in components and CRM applications. The source data and reports may relate to compliance such as know your client, sanctions and screenings, regulatory reporting and transaction monitoring.

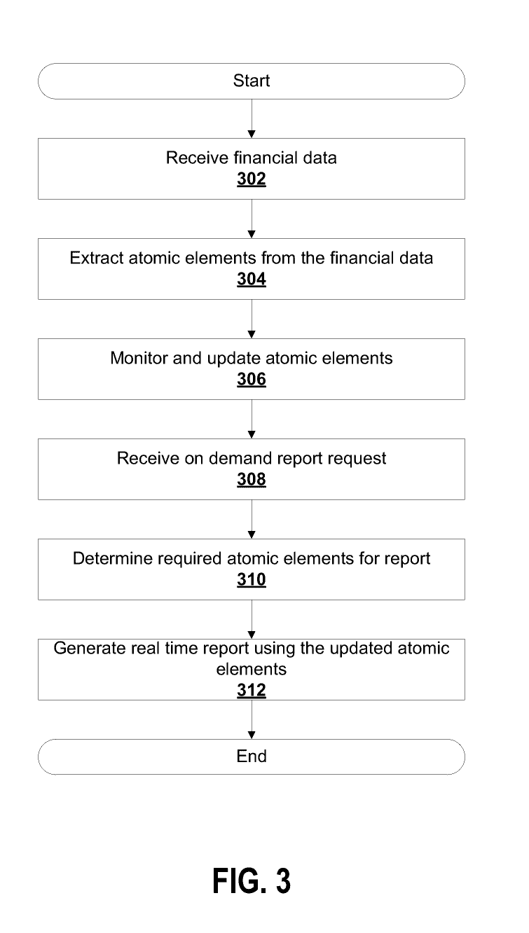

FIG. 3 is a flowchart of a process for simulating financial data over scenarios and models to generate on demand reports and visual representations for banking, insurance or other financial services according to some embodiments.

The platform 100 allows for a report (such as a stress test) to be run under any number of scenarios, using multiple sets of models and different sets of business rules. This allows for comparison of results under any desired combination of scenarios, models and business rules.

At 302, platform 100 receives financial data from data sources 104 or financial institution systems.

At 304, platform 100 extracts atomic elements from the cube 220 or data lake 256. The atomic elements are additive so that the market data is stored in a unified way using one or more common data models. The platform 100 starts with extraction of data from the financial institution systems 110, e.g., the General Ledger to generate the atomic elements. Each institution may have its own special way of recording the transaction so this pre-processing step enables platform 100 to extract atomic elements and store the data in a unified and additive way. The atomic elements are kept up to date so that they are in a form that is ready to respond to on demand reporting requests. The platform 100 uses parallel processor to asynchronously manage the updates to the atomic elements. In contrast, if the data is stored in an aggregated way and if there is an update to component of the aggregated data then the platform 100 would have to undo the aggregation to update the component and then re-aggregated the components. This may use processing resources and it may be difficult to track the components of the aggregated data to understand the impact of updates on the aggregate data.

The data can be extracted from the source systems and archived in a database for any of the institution's activities. This data archiving activity is an on-going one for an institution and independent of any report generation related tasks. Once extracted, however, the atomic elements are ready to serve the on-demand report generation process as well. The platform 100 can “normalize” the data using pre-specified Target Meta Data and Business Rules to derive the atomic elements. A normalized dataset eliminates duplicates, allows for faster updates, inserts and selects since all related pieces of information are held in separate instances.

At 306, platform 100 monitors data sources 104 for updates to the market data used for the atomic elements. The platform 100 uses parallel processing to monitor data sources 104 for updates and to generate corresponding updates to the atomic elements. The platform 100 updates the atomic element asynchronously for report generation.

At 308, platform 100 receives an on-demand report request from financial institution system 110. The report request may indicate one or more types of reports, scenarios, models, rules, input data, format of output data, and so on. The on-demand report request may indicate a set of scenarios (e.g. baseline and stress), a portfolio of financial instruments or holdings, and a set of pricing or valuation models and analytics. The scenarios may map to one or more scenarios managed by scenario unit 216 (or scenario engine 232) or may be additional scenario sets that may be incorporated into platform 100 in real-time. The pricing engine 230 or valuation models may map to one or more models managed by model unit 214 or may be additional models that may be incorporated into platform 100 in real-time. This provides flexibility for scenarios and models.

At 310, platform 100 determines the atomic elements required to respond to the report request. The platform 100 determines if the required atomic elements are available its data store.

To generate the report, platform 100 assembles and aggregates the atomic elements on-demand. The aggregation is asynchronous from the updates to the atomic elements so that the output data can be generated in near real-time. The atomic elements are stored in additive form so that they can be aggregated in various ways on demand to generate the report using different rules, scenarios and models. The user can generate ad hoc aggregations at any desired level by defining such ad hoc aggregations in the on demand report request. The ETL logic unit 208, rather than being disconnected from data or analytics, is stored as data in the platform 100. The user can change the ETL logic (and any rules, models, and scenarios) and see results updated in real time. The transparency is maintained all the way to the transaction data (e.g. atomic elements). Again, the user can change the inputs and see results updated in real time.

At 312, platform 100 generates the output data for the report in real using the updated atomic elements. As noted, the atomic elements are continuously updated independent of report generation so that platform 100 can process on demand report requests in near real time using the updated atomic elements.

The platform 100 is a bottom-up approach whereby information about the risk characteristics of every transaction and loan in a bank's enterprise holdings (e.g. trading as well as banking books) are preserved. This allows for a drill-down to a transaction or a loan through the intermediate aggregation levels that may require further investigation once the stress test results are available. This drill-down capability is also available for tracing back to the original data extracted from source systems in the event that data quality is suspected as the source of an unusual result. The platform 100 aggregation capability allows for alternative aggregation schema to be applied to the underlying data. This enables different user views of the data aggregated based on key characteristics such as geography, business line, maturity bucket, credit rating, counterparty probability of default (PD), and Loss-Given-Default associated with a facility.

The workflow allows for reports to be carried out for any number of scenarios and models. Also, alternative pricing and valuation models can be attached to a transaction or loan. This enables comparison of pricing or valuation models, their validation and calibration.

The cloud-based platform 100 permits on-demand reports in real time through massively parallel computations. As well, the platform 100 provides the “sandbox” feature that enables “what-if” analysis to be carried out on-demand in real time with marginal demands for cloud storage.

The platform 100 provides transparency, consistency and security. The platform 100 uses parallel processors to reduce processing speed and cost. The platform 100 provides real-time updates to source data (atomic elements), on demand aggregation of the atomic elements, and on demand report generation and analytics. The platform 100 provides transparency from atomic elements to the generated report, including the models, scenarios, risk factors, trades and rules used for processing.

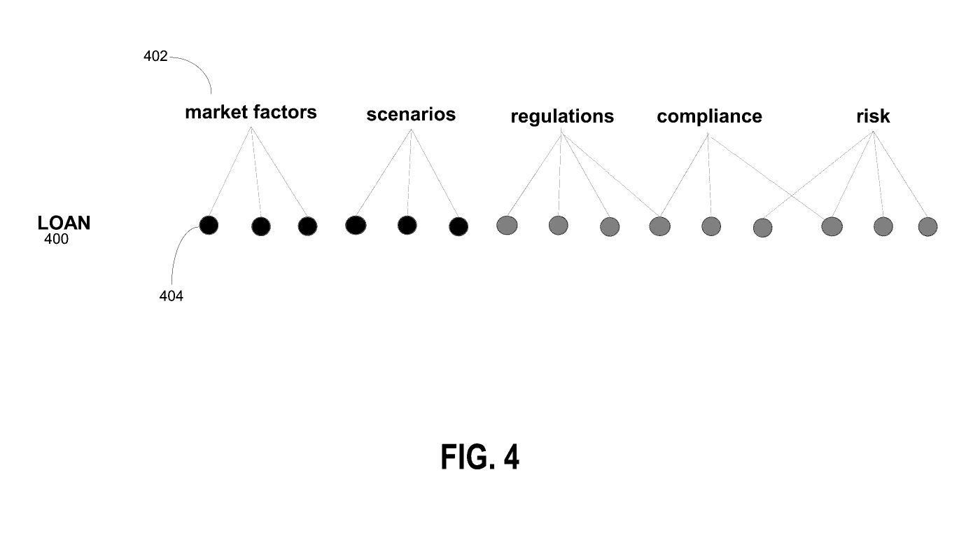

FIGS. 4 to 8 are diagrams of financial instruments, scenarios and functions for multiple pricing engines as example visual representations.

As a simplified example a financial institution has a portfolio of one single type of instrument or security (e.g. a loan 400). FIG. 4 shows an example with a loan 400 with real-time risk management for various business functions 402. The instrument (e.g. loan) is used to derive atomic elements that are arranged to match business functions 402 of a financial institution, such as market factors, scenarios, regulations, compliance and risk management. Source data received as input may include the legal contract which may be broken down into different atomic elements 404. Different atomic elements 404 or values can be derived for the loan for different business functions. These derived values may also be stored as atomic elements 404 and linked to different business functions 402. The platform 100 can generate these derived values from the atomic elements 404 of the loan 400 and for different instruments. The platform 100 ensures that all derived values (also atomic elements) are updated in real time in response to updates to the source data that implicates these values. The platform 100 uses atomic elements to store the data for all instruments in a way that may be aggregated on demand. The atomic elements 404 are additive. For example, the platform 100 may represent a distribution as a histogram so that bars of the histogram are additive. The platform 100 may extract atomic elements 404 from source data that is not currently in additive form. Information is stored in a way that the individual components are additive and ready for any processing that may be demanded. The dots represent atomic elements 404 for the one dimensional instrument 400 example. Data is changing in real-time so the additive values are always changing. The platform 100 updates these atomic elements 404 in response to changes to the source data. The platform 100 codes links between the atomic elements 404 derived for an instrument 400 and the corresponding business function 402. The platform 100 uses parallel engines running in background for managing updates to the atomic elements 404. Anything that impacts that atomic element 404 that changes is flagged by platform 100 to update the atomic element 404. For example, the platform 100 divides the loan 400 data into individual atomic elements 404 and constantly updates the individual atomic elements 404. The platform 100 stores atomic elements 404 in an additive and unified way in its core data store, where atomic elements 404 are essentially “one step” away from original source data. The platform 100 uses parallel processes to keep the atomic elements 404 up to date with asynchronous updates. The platform 100 receives on-demand report request (e.g. decision on a loan, regulatory function). The platform 100 stores everything in additive form, run parallel engines to ensure all data is updated in real-time, and generate on-demand reports. The platform 100 selects or configures an interval for updates (e.g. every 1 min, 2 min, 10 min). The platform 100 receives dynamic report requests and stores atomic elements 404 in a flexible way to respond to different report requirements. The platform 100 implements a data input process without knowing what type of report that will be requested and generated. If a report has an unexpected value then it can be traced to the input data values (used to derive atomic elements 404) in the core. This enables self-correction. The platform 100 needs to store new data values to respond to new regulations and report requests. The platform 100 uses ETL logic to extract atomic elements 404 from the source data. The ETL logic itself is just another form of data that is stored in the data store.

For this example, platform 100 takes the data from the loan 400 and extracts the atomic elements 404 linked to different business functions 402. The atomic elements 404 may include source data and derived data that is still considered to be atomic elements 404. If a new report type is requested then platform 100 does an initial check to make sure it has all the required atomic elements 404 for the report. The report generation requires aggregation of atomic elements 404 which is done asynchronously from the updates to the atomic elements 404. If the required atomic elements 404 are not available then the platform 100 goes back a get any new atomic elements 404 and generates reports. The platform 100 is configured to generate atomic elements 404 derived from source data using models or scenarios or business rules and other atomic elements. The derived data provides different views of the atomic elements 404. The atomic elements 404 store data for different business functions 402. The atomic elements 404 are additive and use one or more common data models for common instruments 400. The atomic elements 404 can be vectors of data values, for example. The atomic elements 404 make up the cube 220 or data lake 256. The cube 220 or data lake 256 provides a uniform way of looking at data for instruments and covers all business functions. The atomic elements 404 can be static data (e.g. a contract for a loan 400) or variable data (e.g. market data).

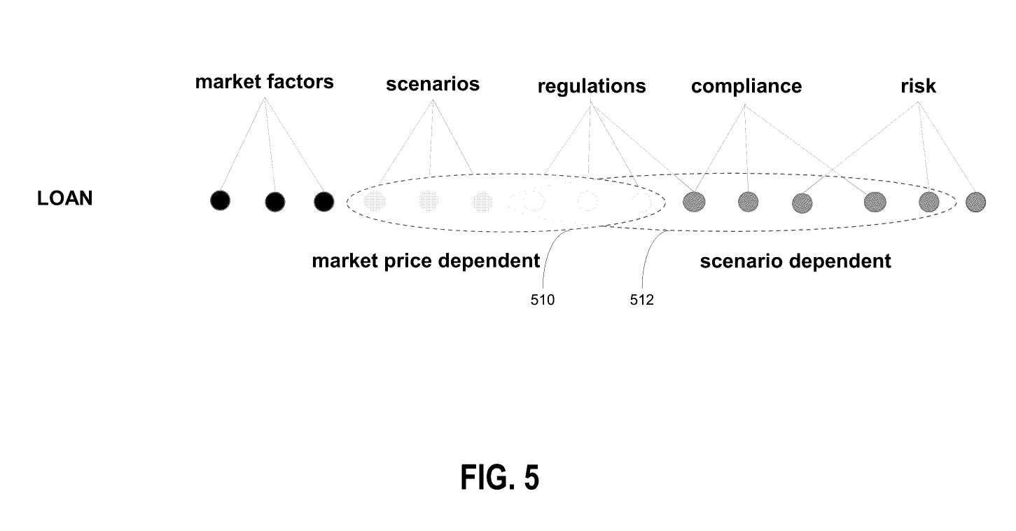

The atomic elements 404 can be dependent on market data and scenarios. As shown in FIG. 5, a set 510 of atomic elements can be market price dependent and another set 512 of atomic elements can be scenario dependent. When the market data or scenarios change a rule triggers a corresponding update to the atomic elements of the sets 510, 512 (by recalculation engine 280, for example). This may be referred to as a data dependency. Data dependencies can be coded as a metadata for the cube 220 or data lake 256.

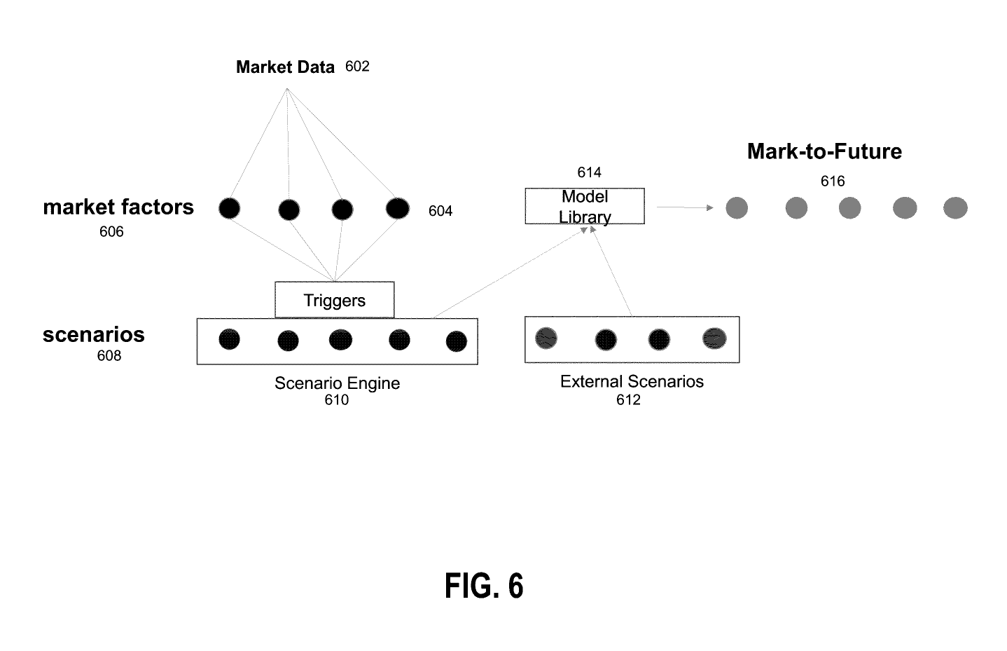

The platform 100 monitors for updates to the data. Each business function 402 relies on a different subset of atomic elements 404. This subset of atomic elements 404 may be referred to as a sub-cube of the cube 220 or a subset of data from data lake 256. Some atomic elements 404 may overlap multiple business functions 402. For example, compliance may overlap atomic elements 404 with risk. As shown in FIG. 6 updates to market data 602 for market factors 606 trigger updates to atomic elements 604 and scenarios 608. A scenario engine 610 controls updates to scenarios 608. The updated scenarios may in turn trigger updates to atomic elements 604 and models of model library 614. External scenario sets 612 can also trigger updates to models of model library 614. The models of model library 614 are used to generate MtF values 616 (which are example atomic elements).

The platform 100 is configured to (1) store source data in atomic form (2) monitor and update the atomic elements using parallel processors and (3) generate on demand reports and aggregate atomic elements to generate the reports. These occur asynchronously and in parallel. The platform 100 asynchronously updates atomic elements and aggregates atomic elements for report generation. The platform 100 has a set of engines for updating the atomic elements cube 220 or data lake 256 and another set of engines for aggregating the atomic elements cube 220 or data lake 256, so that these functions can be implemented asynchronously. For example, a customer may be viewed as a set of instruments (e.g. a portfolio). The set of instruments map to atomic data values that are kept up to date. The atomic data values for the set of instruments are extracted from the cube 220 or data lake 256 and aggregated based on their additive property to generate customer specific reports and output data.

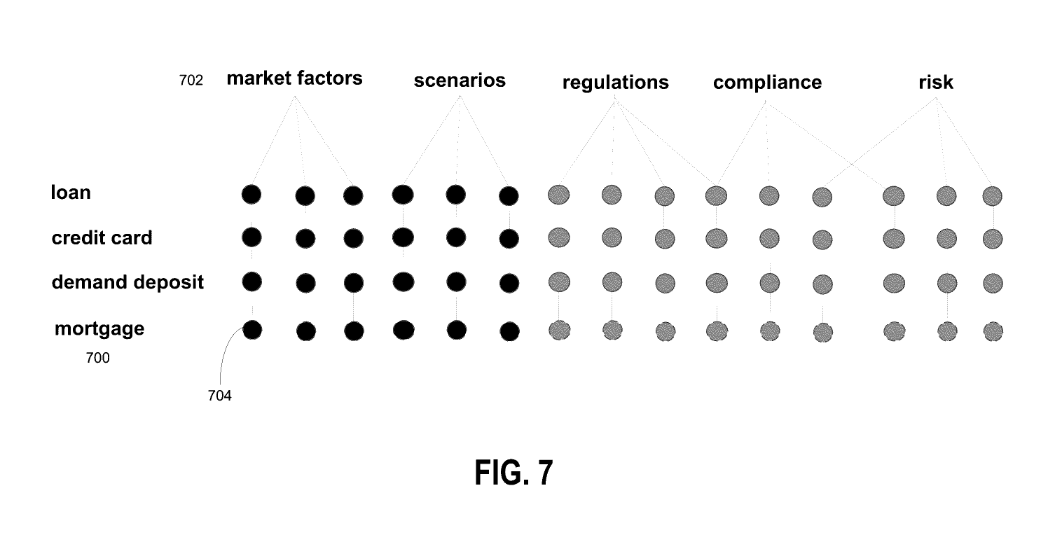

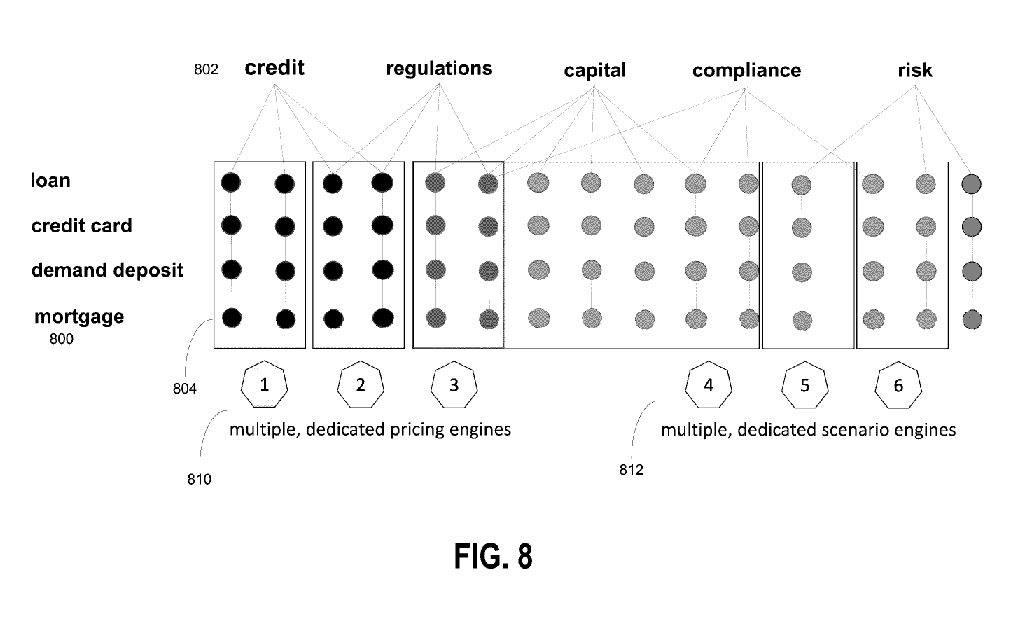

All instruments are modeled using a common data model so that the atomic elements for the instruments are additive. As shown in FIG. 7 a data model can be replicated for all instruments 700 to derive atomic elements 704 for different business functions 702. As shown in FIG. 8, the pricing engines 810 and scenario engines 812 run asynchronously and in parallel to keep atomic elements 804 up to date for instruments 800 and business functions 802.

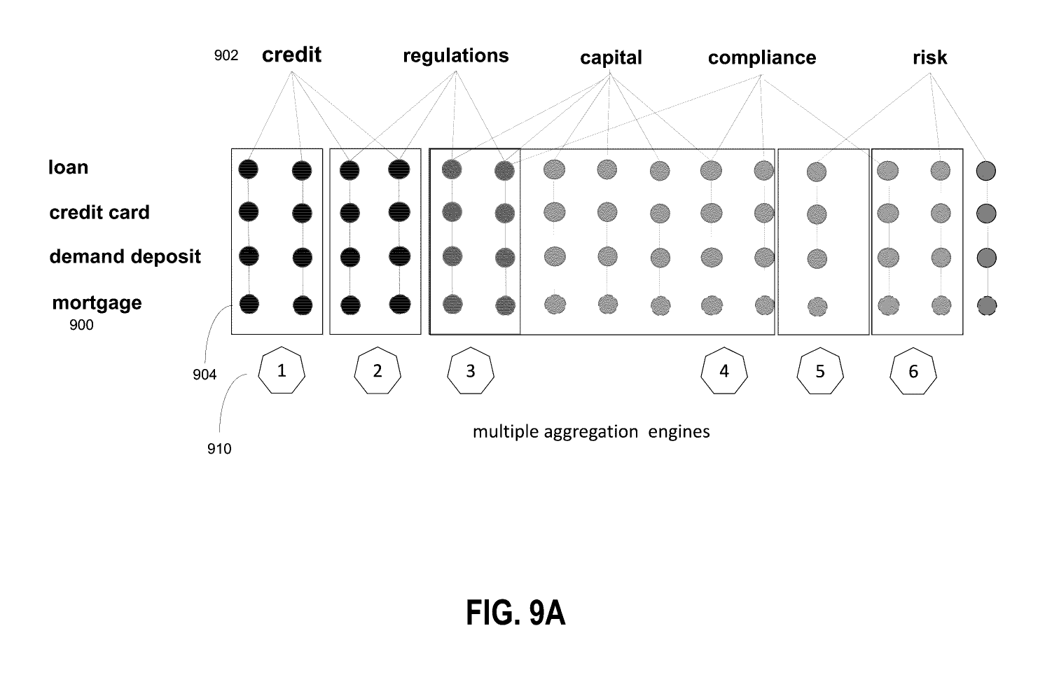

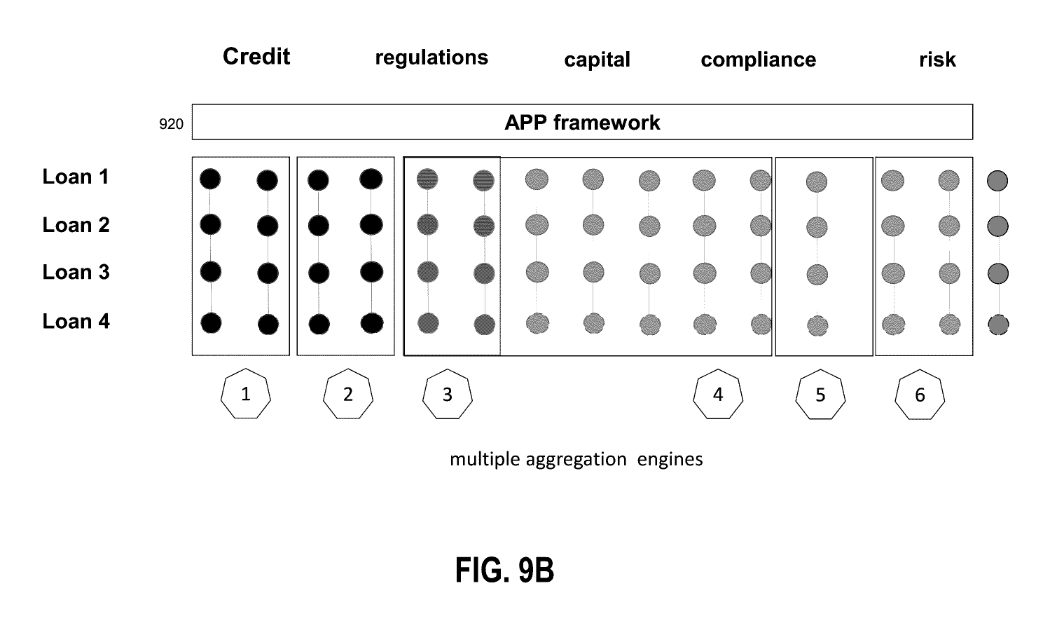

FIGS. 9A and 9B are diagrams of financial instruments, scenarios and functions as example visual representations. As shown in FIG. 9A, the aggregation engines 810 run asynchronously and in parallel to aggregate atomic elements 904 to generate output data for instruments 900 and business functions 902. As shown in FIG. 9B, an application framework 920 can generate or receive on demand requests for reports and in response transmit output data.

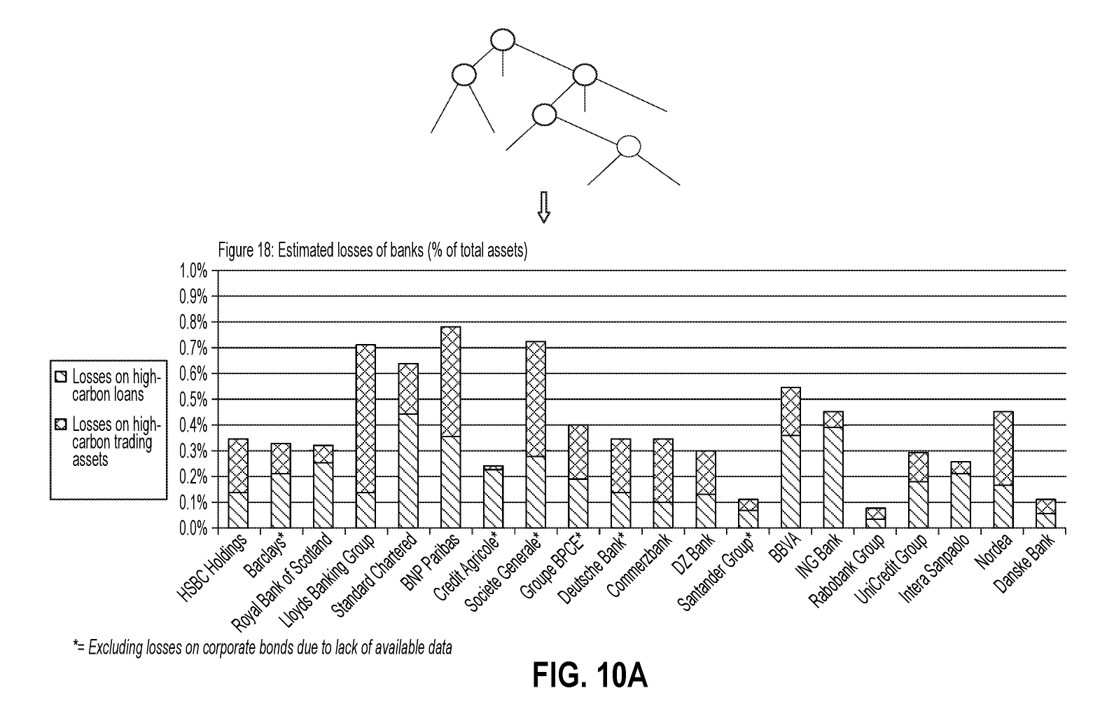

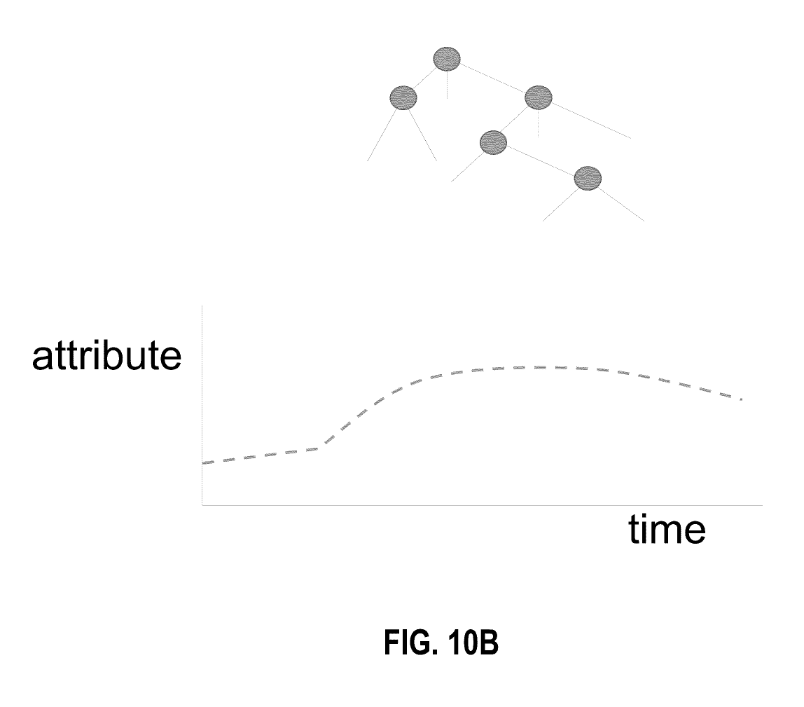

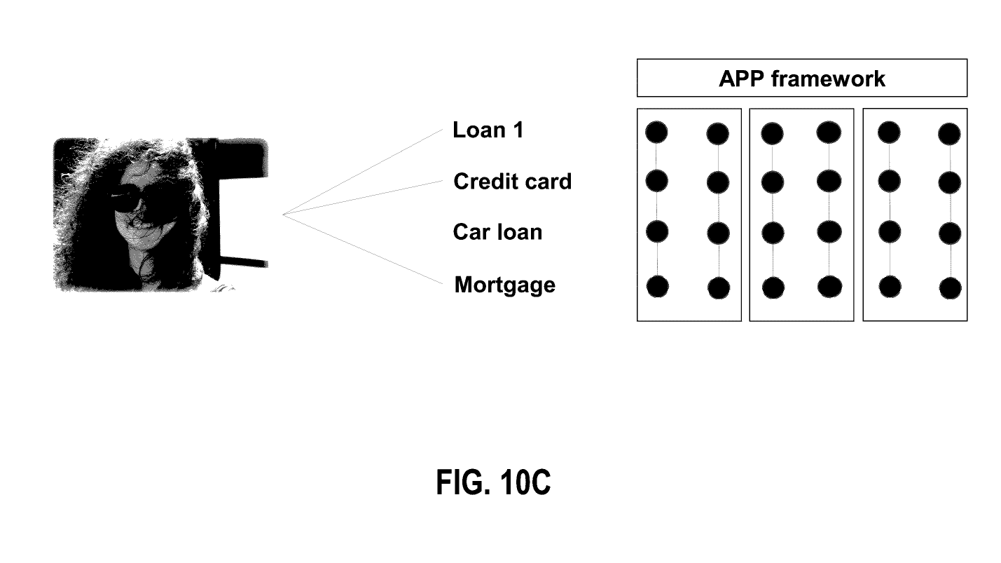

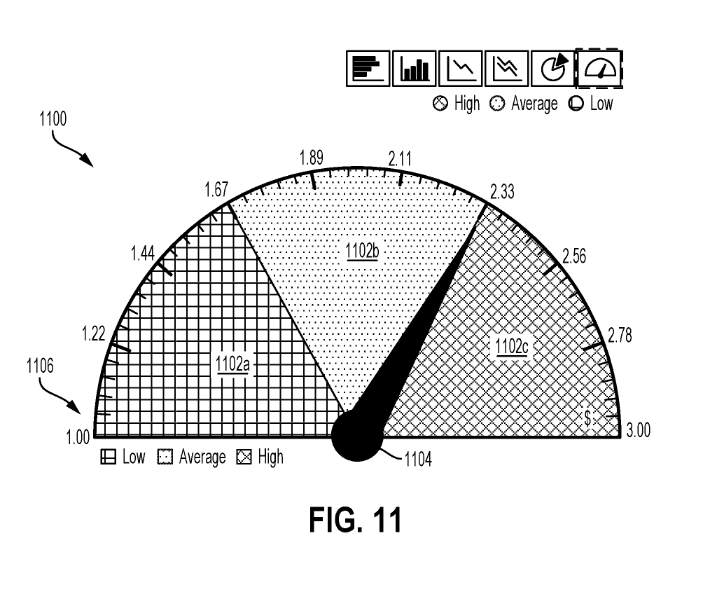

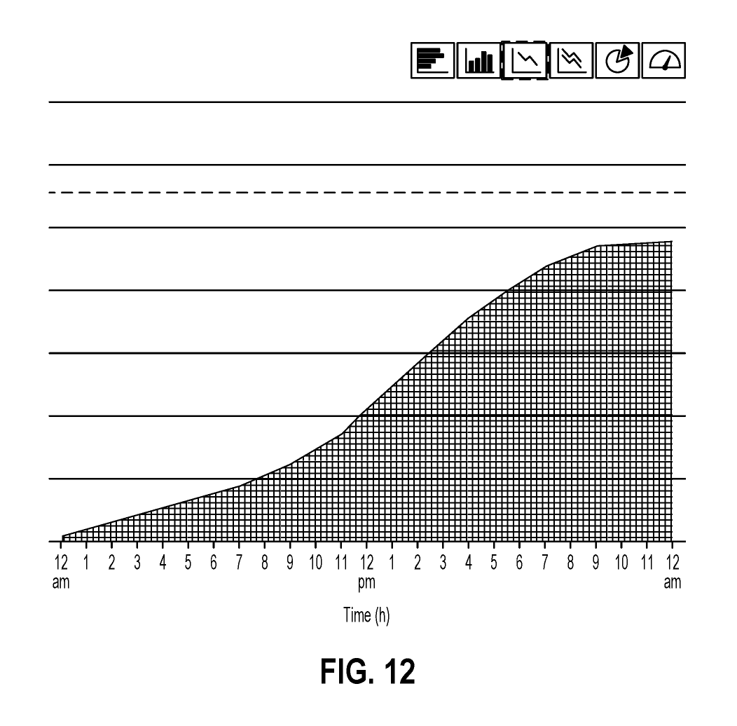

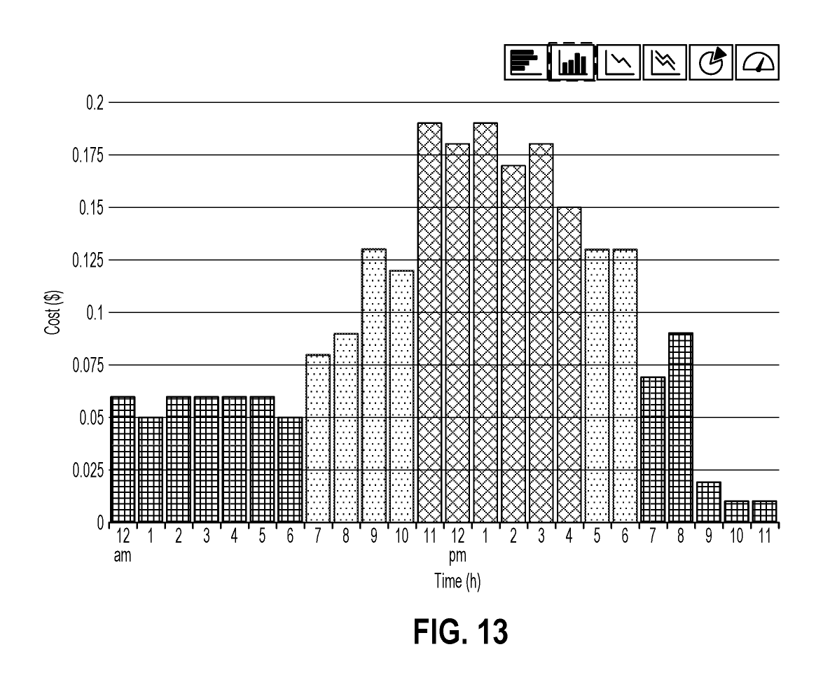

FIGS. 10A and 10B are diagrams of an example user interface providing a visual representation of on-demand financial reporting data according to some embodiments. There can be rapid parallel aggregation of atomic elements to generate output data at different level. This moves from a static reporting model to an on demand dynamic reporting model. The platform 100 provides consistent risk reporting on demand at all levels. The platform provides almost real-time reporting at any level.

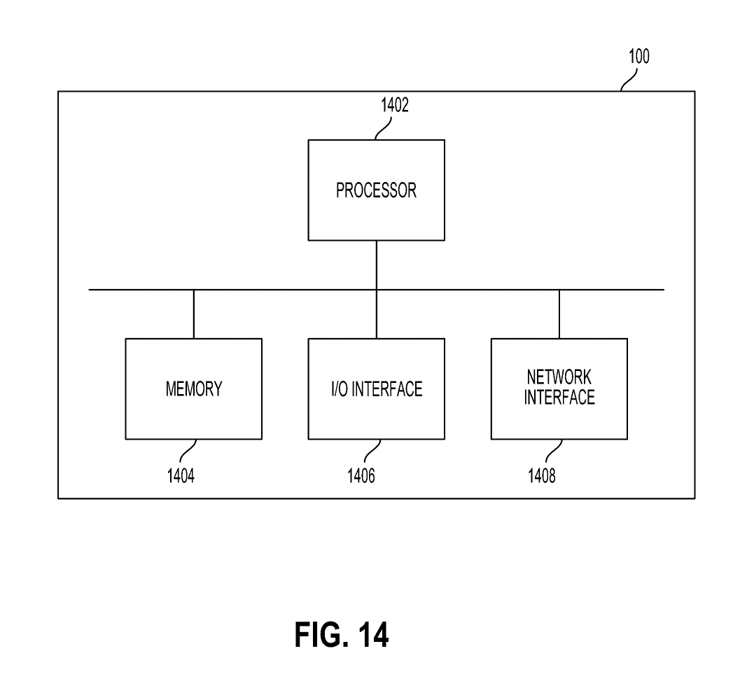

FIG. 100 is a diagrams of financial instruments, scenarios and functions as an example visual representation for an application framework. The customer centric model views a customer as a set of instruments (e.g. loan, credit card, car loan, mortgage) and generates customer specific output data using atomic elements linked to the set of instruments.

FIG. 11 is a diagram of an example user interface providing a visual representation 1100 of on-demand financial reporting data according to some embodiments.

The visual representation 1100 is graphical user interface for a gage having three data segments 1102, 1120b, 1102c arranged along a scale 1106 of data points. The gage has an indicator 1104 representing a current data value relative to the scale of data points. The indicator 1104 has a position within the gage. The visual representation 1100 may provide continuous real-time or near real-time benchmarking of output data for an entity. The visual representation 1100 is report that may dynamically update by changed the position of the indicator 1104.

The platform 100 is configured to generate the visual representation 1100 and update the position of the indicator 1104 in real time in response to computed output data values (e.g. report values).

The platform 100 determines an approximate normal distribution for output data for the entity by estimating a mean and a standard deviation. The financial data includes data values, each data value being associated with a time interval for a historical date. The platform 100 generates a graphical representation of data segments 1102, 1120b, 1102c. The data segments 1102, 1120b, 1102c being approximately equal in size when displayed as part of the graphical user interface. The data segments 1102, 1120b, 1102c are generated based on the approximate normal distribution of the financial data, the mean and the standard deviation. The data segments 1102, 1120b, 1102c represent a scale of data values as they compare to the estimated mean. Each data segment 1102, 1120b, 1102c provides boundaries along the scale 1106 of data values and representing a different range of values. A data segment 1102b represents an average value with a first range of data values along the scale 1106. Another data segment 1102a represents a less than average value with a second range of data values along the scale. Another data segment 1102c represents a greater than average value with a third range of data values along the scale 1106. The first range of data values, the second range of data values and the third range of data values being different even though the data segments are approximately equal in size when displayed as part of the graphical user interface. More common data values are spread out along the scale and less common data values are compacted along the scale.

As an example, a data segment 1102b represents financial data within the approximate range X(t′)<μ−(0.491)σ. A data segment 1102a represents financial data within the approximate range μ−(0.451)σ<X(t′)<μ+(0.491)σ. A data segment represents financial data within the approximate range X(t′)>μ(0.491)σ. X(t′) is an financial data point, μ is the estimated mean, and σ is the estimated standard deviation.

The platform 100 collects real-time or near real-time market data relevant to instruments and business functions of the entity to continuously receive a real-time data values associated with the time interval for a real-time date. The platform 100 generates the graphical user interface for display on a device. The visual representation 1100 is a graphical representation benchmarking the real-time or near real-time financial data against historical financial data, for example. The graphical representation illustrates the data segments as approximately equal in size and represents the real-time or near real-time financial data as a graphical element indicator 1104 at a position on the scale within one of the data segments 1102, 1120b, 1102c to represent how the real-time data value compares to the estimated mean for the distribution of the historical financial data in order to benchmark the real-time or near real-time financial data against the historical financial data.

The platform 100 continuously collects additional real-time or near real-time financial data for the entity to receive real-time updates as additional real-time data values associated with the time interval for the real-time date.

The platform 100 continuously updates the visual representation 1100 based on the additional real-time or near real-time financial data to move the graphical element indicator 1104 to different positions along the scale for the data segments. This indicates how the additional real-time data values associated with the time interval compare to the estimated mean in order to provide a continuously real-time or near real-time benchmark against the historical financial data.

The visual representation 1100 provides an improved mechanism for generating graphical user interfaces to enable an effective visual display of how real-time financial data benchmarks or compares to historical financial data. The visual representation 1100 displays data segments as being approximately equal in size when displayed as part of a graphical user interface even though each individual range is not equal. More common values are spread out over the scale and the outliers or less common values compacted at the extreme ends of scale. Calculating the segments 1102, 1120b, 1102c based on the estimated mean and standard deviations enables an effective visual display of how real-time financial data benchmarks or compares to historical financial data as the more common values are spread out over the scale 1106 and the outliers or less common values are compacted at the extreme ends of scale 1106. This recognizes that the indicator 1104 will be more often hovering around the mean, μ−(0.491) σ and μ+(0.491) σ and less likely to be on the extreme ends. Otherwise the indicator 1104 may mostly be positioned within a small area of the gage and it may be difficult for a user to notice fluctuations around the mean, μ−(0.491) σ and μ+(0.491) σ as the may be represented in a smaller portion of the scale 1106.

The visual representation 1100 may compare real-time financial data benchmarks or compares to historical financial data. The visual representation 1100 may also compare one entity's financial data to another entity's financial data. For example, the indicator 1104 may represent a trader within an organization and indicate how its RAPL compares to other traders, for example. It may be average, below average or above average. The indicator 1004 may refer to a trading limit, VaR or other risk values.

FIGS. 12 and 13 are example charts providing a visual representation of on-demand financial reporting output data according to some embodiments.

FIG. 14 is a schematic diagram of a computing device to implement aspects of simulation platform for banking, insurance or other financial services according to some embodiments.

The platform 100 providing SaaS may also fill a need for benchmarks that allows financial institutions to compare their portfolios' stress tests to those of their peers, in a completely anonymous manner.

The platform 100 brings the power of big data, massively parallel processing, on-demand input data assembly, and “the cloud” to risk management. The stress testing is performed in near real time and will enhance the way financial institutions assemble data, view and manage their risk. For example, banks may query the computing platform providing STaaS to execute “what if” analysis in minutes rather than days using the improved processing techniques.

There is a need for benchmarking by financial institutions of how they perform relative to their peer group under stress. Finally, stress testing is fundamental to risk management of financial institutions and is not simply a compliance issue as it is most often seen to be. The platform 100 may provide risk management and benchmarking results.

The platform 100 may offer major banks a stress testing solution that will permit them to benchmark their in-house stress testing with a robust, independent stress testing solution. It may permit banks to view their stresses independently and anonymously against a group of their competitors. It may also provide the board of banks with independent oversight of their stress testing capabilities.

The platform 100 can offer rapid stress testing of an entire portfolio of a bank. It may bring stress testing out of the realm of regulatory compliance and into the mainstream management of a bank's portfolio. The computing platform providing STaaS may solve the problem of quick, on-demand assembly of all input data. This may be done without requiring the use of intermediate data storage, data marts, and data warehouses. Additional saving of time is achieved through massive use of parallel processing.

For example, the platform 100 may be used by small to medium-sized bank that may not have a multibillion-dollar IT budget and cannot afford to produce its own stress testing. The STaaS solution may cut the costs of stress testing for these banks and provide them with stress testing.

The platform 100 may enable the rapid stress testing of very large and complex portfolios. The technology combines, financial engineering, big data and massive parallel processing engines in “the cloud” to enable the stress testing of multiple financial institutions rapidly and economically at a speed that not available anywhere today.

The platform 100 providing SaaS may offer its services securely and confidentially. It may require very little infrastructure from the institution being tested. It may offer independent verification of the institution's own stress tests as well as independent oversight and benchmarking reports to the board. The SaaS model may change the industry and change the way risk is managed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may provide improved data transformations, improved memory usage, improved processing, improved aggregation, improved bandwidth usage, and so on.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

For simplicity only one stress testing computing platform is shown but system may include more platforms operable by users to access remote network resources and exchange data. The computing platform may be the same or different types of devices. The computing platform may be implemented using multiple processors and data storage devices (including volatile memory or non-volatile memory or other data storage elements or a combination thereof), and at least one communication interface to interface with different input data sources and provide output data to different end-user devices. The computing platform components may be connected in various ways including directly coupled, indirectly coupled via a network, and distributed over a wide geographic area and connected via a network (which may be referred to as cloud computing).

FIG. 14 illustrates an example computing device that may implement aspects of platform 100. Platform 100 may have a processor 1402, memory 1404, I/O interface 1406, and a network interface 1408.

The processor 1402 may be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1404 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1406 enables computing platform to interconnect with one or more input devices, such as a keyboard, mouse, camera, touch screen and a microphone, or with one or more output devices such as a display screen and a speaker.

Each network interface 1408 enables computing platform to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Computing platform 100 is operable to register and authenticate users (using a login, unique identifier, and password for example) prior to providing access to applications, a local network, network resources, other networks and network security devices. Computing platform may serve one user or multiple users.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A risk management platform comprising:
an interface configured to receive input data from data sources, transforms the input data to compute atomic elements, and store the atomic elements in a distributed data storage device, the atomic elements being additive and modeled using a common data model;
a first set of parallel processor engines configured to continuously monitor the data sources to detect updates to the input data, and generate corresponding updates to the atomic elements in the distributed data storage device;
a second set of parallel processor engines to operate on the updated atomic data elements using ETL logic and aggregate the atomic elements using rules; and
a reporting unit configured to receive on an demand request for an electronic real-time report, determine required atomic elements for generating the report, trigger the second set of parallel processor engines to aggregate the atomic elements on demand, and generate the report using the aggregated atomic elements, the report providing a plurality of visual representations of the aggregated atomic elements.

2. The risk management platform of claim 1 wherein the first set of parallel processor engines operates asynchronously from the second set of parallel processor engines.

3. The risk management platform of claim 1 wherein the input data relates to market factors, instruments and scenarios, and wherein the atomic elements form a cube structure of mark to future values for each of a plurality of instruments, wherein the mark to future value for an instrument is a simulated expected value for the instrument under a scenario at a time point.

4. The risk management platform of claim 1 wherein the atomic elements correspond to different instruments and different business functions.

5. The risk management platform of claim 1 wherein the second set of parallel processor engines to determine that the required atomic elements are available in the data storage device before the aggregation.

6. The risk management platform of claim 1 wherein the interface comprises a market data connector to automatically download market data as the input data from the data sources.

7. The risk management platform of claim 1 wherein the interface comprises a data manager that controls persistence of the atomic elements in a cube data structure or data lake, and transfers the atomic elements to and from an in-memory data cache.

8. The risk management platform of claim 1 wherein the input data comprises market factor data for pricing and scenarios, and wherein the interface comprises a market factors manager that controls the persistence of the market factor data in a data storage and transfers the market factor data to and from an in-memory data cache.

9. The risk management platform of claim 1 wherein the first set of parallel processor engines comprises a pricing engine that monitors updates to input data relating to market pricing and triggers recalculation of a set of atomic elements for the market pricing.

10. The risk management platform of claim 1 wherein the first set of parallel processor engines comprises a scenario engine that monitors updates to input data relating to scenario set variables and triggers recalculation of a set of atomic elements for the scenario set variables.

11. The risk management platform of claim 1 wherein the atomic elements provide a set of data needed to compute measurements for all functions that a bank performs in the course of its business.

12. The risk management platform of claim 1 wherein the atomic elements of an instrument are values needed to compute relevant measurements related to the instrument.

13. The risk management platform of claim 1 wherein the atomic elements of a portfolio of instruments are equal to the sum of the atomic elements for the individual instruments of the portfolio.

14. The risk management platform of claim 1 wherein the interface can switch between different data sources and connect with multiple data sources.

15. The risk management platform of claim 1 wherein the aggregated atomic elements are computed automatically to value a hierarchy of portfolios of instruments against a set of scenarios, wherein the computation is triggered by one or more rules relating to changes in market factors for the set of scenarios or changes to the set of scenarios.

16. The risk management platform of claim 1 wherein the first set of parallel processor engines automatically scales as a scope of calculations for the atomic elements increases.

17. The risk management platform of claim 1 wherein the defines links for dependencies between input data and atomic elements, and between two or more atomic elements, such that an update to the input data triggers a corresponding update to the atomic elements based on the defined links and an update to the atomic elements triggers a corresponding update to the atomic elements based on the defined links.

18. A risk management platform comprising:
an interface configured to receive input data from data sources, transform the input data into atomic elements using one or more common data models, and store the atomic elements in a distributed cloud data storage device, the atomic elements being additive and representing data required for business functions of a financial institution;
a first set of parallel processor engines configured continuously monitor the data sources to detect updates to the input data, and generate corresponding updates to the atomic elements in the data storage device;
a second set of parallel processor engines to operate on the updated atomic data elements using ETL logic and aggregate the atomic elements using models, scenarios and rules, the a second set of parallel processor engines triggered in response to an demand request for an electronic real-time report;
the first set of parallel processor engines and the second set of parallel processor engines operating asynchronously; and
a reporting unit configured to trigger the second set of parallel processor engines to aggregate the atomic element on demand and in real-time and generate a plurality of visual representations of the aggregated atomic elements.

19. The risk management platform of claim 18 wherein the interface comprises a market data connector to automatically download market data as the input data from the data sources and switch between different data sources and connect with multiple data sources.

20. A method for risk management comprising:
receiving at an interface input data from multiple data sources;
transforming, using a processor, the input data into atomic elements using one or more common data models, the atomic elements being additive and representing data required for business functions of a financial institution;
storing the atomic elements in a distributed cloud data storage device;
continuously monitoring the data sources, using a first set of parallel processor engines, to detect updates to the input data, and generate corresponding updates to the atomic elements in the data storage device;
operating on the updated atomic data elements using a second set of parallel processor engines to and ETL logic to aggregate the atomic elements using models, scenarios and rules, the operating triggered in response to an demand request for an electronic real-time report, the updates to the atomic data elements being asynchronous from the aggregation of the updated atomic data elements; and
generating a plurality of visual representations of the aggregated atomic elements on demand and in real-time.
